(19) United States
(12) Patent Application Publication
(10) Pub. No.: US 2020/0156928 A1
(43) Pub. Date: May 21, 2020

(54) J Stirrup

(71) Applicant: Sahali Tack, LLC, Spokane, WA (US)

(72) Inventors: James Edward Molini, Spokane, WA (US); Steve David Podleski, Spokane, WA (US); Richard Augustus Mazzola, Spokane, WA (US)

(21) Appl. No.: 16/193,806

(22) Filed: Nov. 16, 2018

(51) Int. Cl. B68C 3/02

(52) U.S. Cl. CPC B68C 3/02; B68C 2003/0091

(57) ABSTRACT

A stirrup design that reduces the chances of a rider's foot getting caught during riding or unexpected dismounting. The stirrup includes a foot plate, a U-shaped attachment shank, and a connecting structural member. The U-shaped shank attaches to a saddles strap and includes a first shank leg, a second shank leg, and a web shank. The foot plate supports the rider's foot and is mounted offset to the U-shaped attachment shank by the connecting structural member. The first shank and the second shank are oriented normal to the foot plate to horizontally suspend the foot plate. The first shank leg is positioned parallel and coincident with a sagittal plane of the foot plate, directly over the foot plate. For comfort, a sagittal plane of the U-shaped attachment shank is oriented at a first acute angle with the sagittal plane of the foot plate.

### FIELD OF THE INVENTION

The present invention generally relates to an alternative saddle design. More specifically, the present invention is an alternative design for a stirrup that reduces the chances of a rider getting caught in the stirrup during while riding. The present invention also improves support for the rider as well as allow the rider to wear a wider variety of footwear when compared to traditional stirrup designs.

### BACKGROUND OF THE INVENTION

A stirrup is a light frame or ring that holds the foot of a rider, attached to the saddle by a strap, often called a stirrup leather. Stirrups are usually paired and are used to aid in mounting and as a support while using a riding animal (usually a horse or other equine, such as a mule). Stirrups are used to improve rider stability and support mounting large animals. By providing a place for bracing the feet of a rider, stirrups increase the number of points of support for the rider during movement, such as walking, trotting, galloping, and jumping. Stirrups, in some form, have been in use since the late 2nd century BC.

The traditional style of stirrup has conformed to a basic loop design, whether made of rope, leather, or metal. Stirrups in use since the 16th century have been designed as a U-shaped support piece connected to a footplate that that ran across the ball of the rider's foot. There are, however, safety concerns associated with the use of stirrups described here, including a risk that a fallen rider may get a foot caught in the stirrup and be dragged by the horse. A rider's foot can slip forward and through the stirrup or become wedged inside the stirrup during or after a fall. Further movement of the horse can then cause the rider to be dragged behind the horse. Most riding instructors require riders to use footwear with heels to reduce the chance that a foot can be caught in a stirrup, but this practice is not universally effective, as is demonstrated by research finding that an average of 350 people in the USA are involved in accidents each year where a foot has been caught in a conventional stirrup.

In prior art “safety stirrups” recognized the risk that a rider's foot could become caught inside the loop of the stirrup, resulting in injury or death if the rider was unintentionally thrown or dismounted. These “safety stirrups” often are constructed with the same U-shaped stirrup structure with some form of breakaway material that could enable a rider to pull or kick free when necessary.

The present invention is a riding support that changes the orientation of the support and integrates a cantilever shank design to improve support for the rider's foot while virtually eliminating the chance that the rider's foot can get caught in the stirrup during an unanticipated dismount. In this way, the present invention eliminates the “ring” or “loop” structure of the traditional stirrup. The present invention is designed to provide support for the ball and toes of a rider's foot, dispersing the weight of the rider and improving the feel of the stirrup. The present invention also implements a different load transfer system, allowing the rider to ride in a heels-up or heels-down configuration. The aforementioned features permit riders to wear a wider variety of footwear, such as lug sole boots, or running shoes, by improving the ability to disengage from the stirrup during a dismount.

### BRIEF DESCRIPTION OF THE DRAWINGS

FIG. 1 is a perspective view of the present invention.

FIG. 2 is a perspective view of the present invention in an exploded state.

FIG. 3 is a top view of the present invention.

FIG. 4 is a right-side elevation view of the present invention.

FIG. 5 is a right-side elevation view of an alternative embodiment of the present invention.

### DETAIL DESCRIPTIONS OF THE INVENTION

All illustrations of the drawings are for the purpose of describing selected versions of the present invention and are not intended to limit the scope of the present invention.

The present invention generally relates to mechanisms and devices used for riding a horse. More specifically, the present invention is an alternative design for a stirrup that changes the orientation of the support in relation to a rider's foot and integrates a cantilever shank design to improve support for the rider's foot while virtually eliminating the chance that the rider's foot can get caught in the present invention during an unanticipated dismount. The present invention aligns in parallel with the sole of a rider's foot to provide support for the whole foot, disperse the weight of the rider, and improve comfort for the rider. The front-to-back or parallel orientation of the present invention allows a rider to ride in a heels-up or heels-down configuration. Resultantly, the aforementioned improvements permit the rider to wear a wider variety of footwear, such as lug sole boots, or running shoes, without concern for the increased likelihood of catching a foot in the present invention during a dismount.

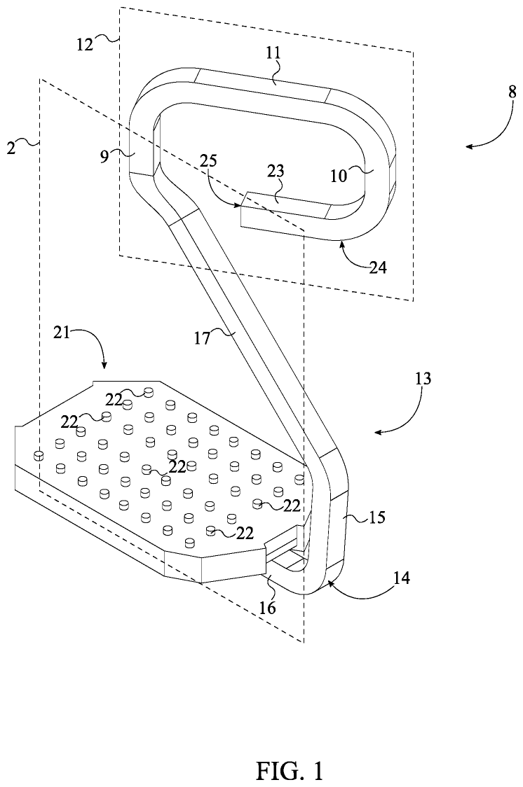

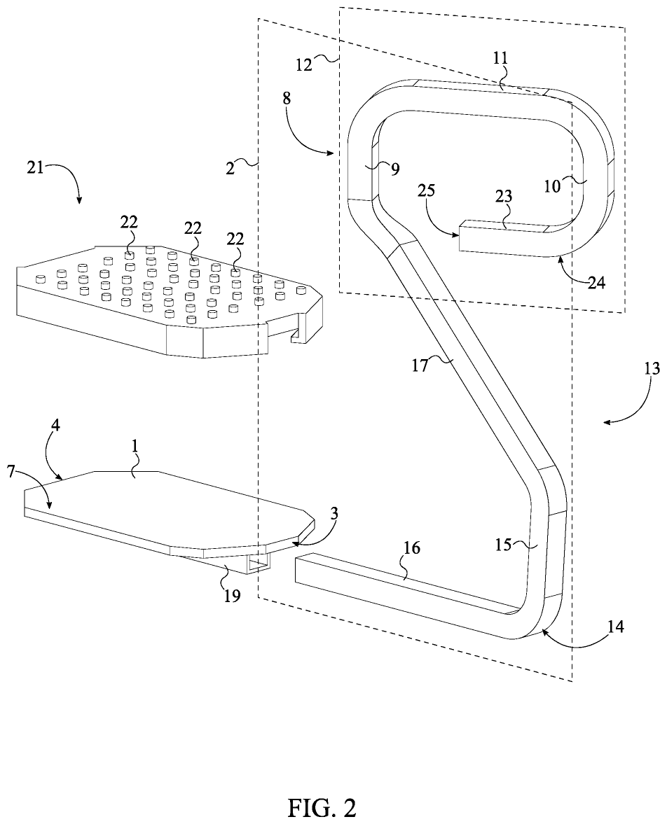

Referring to FIG. 1 and FIG. 2, the present invention comprises a foot plate 1, a U-shaped attachment shank 8, and a connecting structural member 13. The foot plate 1 supports the rider's foot. The foot plate 1 is an elongated rigid plate that runs parallel to the rider's foot from the toes to the heels of the foot. Relative to traditional designs, because the rider's foot runs along the length of the foot plate 1, the present invention reorients load transfer from a pure vertical load over a small perpendicular support to a cantilever mounted load along an extended surface. Resultantly, the present invention increases the number of contact points between horse and rider, thereby improving the ability of the rider to provide subtle cues regarding direction and movement to the horse. The U-shaped attachment shank 8 and the connecting structural member 13 attach the foot plate 1 to a saddle strap. Specifically, the U-shaped attachment shank 8 and the connecting structural member 13 suspend the foot plate 1 directly underneath the saddle strap in a horizontal orientation. The U-shaped attachment shank 8 attaches the present invention to the saddle strap. The connecting structural member 13 mounts the U-shaped attachment shank 8 to the foot plate 1 at an offset distance and in a cantilever configuration, i.e. the connecting structural member 13 laterally supports the foot plate 1. This delineates a space where the rider may place his or her foot on the foot plate 1. Specifically, the foot plate 1 is mounted offset to the U-shaped attachment shank 8 by the connecting structural member 13.

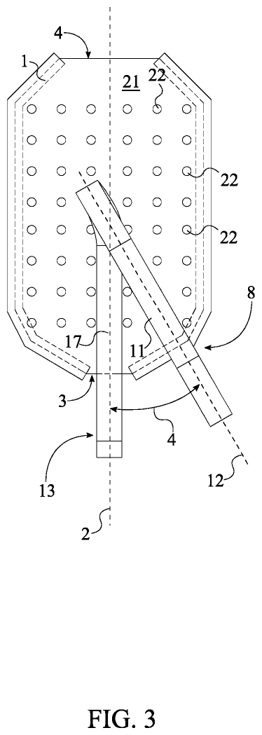

In the simplest embodiment of the present invention, the U-shaped attachment shank 8 is an elongated rod or tubular structure that is bent 90 degrees at two points to yield an overall U-shape. Resultantly, the U-shaped attachment shank 8 comprises a first shank leg 9, a second shank leg 10, and a web shank 11. The saddle strap attaches to the web shank 11 and supports the present invention. For this, the web shank 11 is oriented parallel to the foot plate 1 to ensure that the foot plate 1 is suspended in a horizontal orientation. The first shank leg 9 and the second shank leg 10 prevent the saddle strap from slipping off from the web shank 11 and, thus, the first shank leg 9 and the second shank leg 10 are oriented normal to the foot plate 1. Specifically, the U-shaped attachment shank 8 is oriented towards the foot plate 1, wherein the web shank 11 is positioned parallel and opposite to the foot plate 1, across the first shank leg 9 and the second shank leg 10. This configuration hooks the U-shaped attachment shank 8 to the saddle strap and reduces the chances for the present invention to disconnect from the saddle strap. Referring to FIG. 3, the U-shaped attachment shank 8 is positioned directly over the foot plate 1 to ensure that the foot plate 1 is supported in a horizontal orientation directly under the U-shaped attachment shank 8. For this, the first shank is positioned parallel and coincident with a sagittal plane 2 of the foot plate 1. The sagittal plane 2 of the foot plate 1 is defined as a plane that bisects a body along the longitudinal axis of the body; the sagittal plane 2 of the foot plate 1 extends from a front end 3 of the foot plate 1 to a rear end 4 of the foot plate 1, bisecting the foot plate 1 into two symmetrical portions. Additionally, the first shank leg 9 is positioned adjacent to the rear end 4 of the foot plate 1 and is terminally connected to the connecting structural member 13.

One important aspect of the present invention is the relative orientation between the U-shaped attachment shank 8 and the foot plate 1. To ensure rider comfort and easy foot placement the foot plate 1 extends along the length of the horse with the U-shaped attachment shank 8 being oriented at an angle with the foot plate 1. Referring to FIG. 3, a sagittal plane 12 of the U-shaped attachment shank 8 is oriented at a first acute angle 5 with the sagittal plane 2 of the foot plate 1. For this, the second shank leg 10 is positioned adjacent to the front end 3 of the foot plate 1 and is positioned offset from the sagittal plane 2 of the foot plate 1. In the preferred embodiment of the present invention, the first acute angle 5 may range between 20 to 40 degrees to meet the needs and preferences of the rider. This configuration improves acquisition of the stirrup and comfort of the rider. When the present invention is attached to the saddle strap, the first acute angle 5 orients the foot plate 1 more closely to the rider's foot when acquiring the stirrup while the rider is mounted.

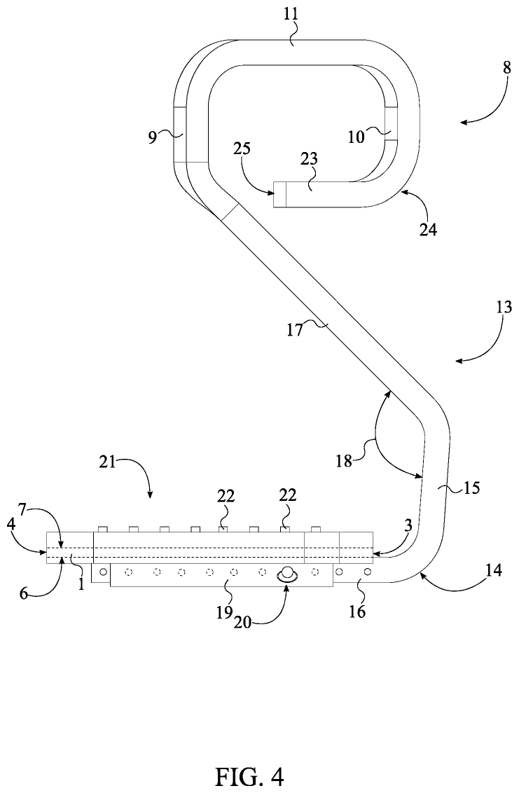

Referring to FIG. 4, the connecting structural member 13 comprises an L-shaped support shank 14 and an interconnecting shank 17. The L-shaped support shank 14 mounts to the foot plate 1 while the interconnecting shank 17 connects to the U-shaped attachment shank 8. The connecting structural member 13 is positioned adjacent to the front end 3 of the foot plate 1 and is implemented as a single rod or tubular structure that laterally extends from the foot plate 1. This design ensures that during an unintentional dismount, the rider's foot cannot hook onto, get stuck on/in, or latch onto any portion of the present invention. Additionally, the L-shaped support shank 14 and the interconnecting shank 17 are positioned parallel and coincident with the sagittal plane 2 of the foot plate 1. The L-shaped support shank 14 comprises a first support leg 15 and a second support leg 16. The first support leg 15 vertically offsets the interconnecting shank 17 from the foot plate 1 and is positioned adjacent to the front end 3 of the foot plate 1. Additionally, the first support leg 15 allows the rider to know whether or not his or her foot is properly placed within the present invention. Proper placement is defined by the rider's toe being pressed against and in contact with the first support leg 15. The second support leg 16 is centrally mounted along the foot plate 1 to provide extended support to the rider's foot along the whole length of the foot plate 1 for increased feedback from the horse. The interconnecting shank 17 connects the L-shaped support shank 14 to the U-shaped attachment shank 8. Specifically, the interconnecting shank 17 is terminally connected to the first support leg 15, opposite the second support leg 16 and extends towards the rear end 4 of the foot plate 1. The U-shaped attachment shank 8 is positioned adjacent to the interconnecting shank 17, opposite the first support leg 15. Resultantly, the U-shaped attachment shank 8 is positioned directly overlapping the foot plate 1. The first shank leg 9 is terminally connected to the interconnecting shank 17 such that the first shank leg 9 is positioned coincident or adjacent to the center of gravity of the foot plate 1. In the preferred embodiment of the present invention, the U-shaped attachment shank 8, the interconnecting shank 17, and the L-shaped support shank 14 are implemented as a single rod or tubular structure for improved feel for the rider and for improved product longevity.

Referring to FIG. 4, because the interconnecting shank 17 and the L-shaped support shank 14 are aligned with the sagittal plane 2 of the foot plate 1 and extends from the front end 3 of the foot plate 1, the rider is capable of wearing a wider variety of footwear as there is no loop-like structure in which the rider's foot may get caught in. This configuration and design increase the safety and comfort of the rider. In order to use the present invention, the rider may laterally slide his or her foot onto the foot plate 1. Additionally, the rider may slide his or her foot onto the foot plate 1 traditionally, from the rear end 4 of the foot plate 1 towards the front end 3 of the foot plate 1.

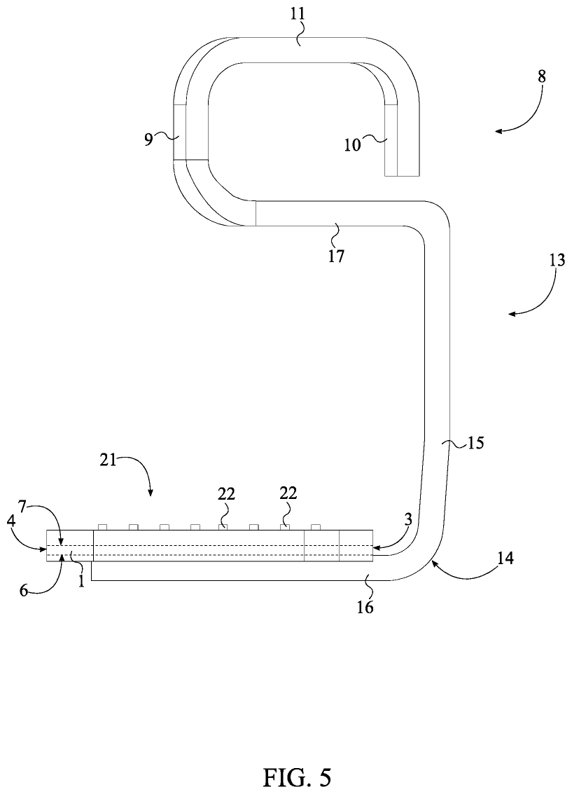

Referring to FIG. 4, in one embodiment of the present invention, the interconnecting shank 17 is oriented at a first obtuse angle 18 with the support leg in order to create additional clearance in between the foot plate 1 and the U-shaped attachment shank 8. Said clearance is designed for the placement of the rider's foot. Referring to FIG. 5, in another embodiment of the present invention, the first support leg 15 is significantly longer, and the interconnecting shank 17 is oriented parallel to the foot plate 1.

In the preferred embodiment, the present invention allows the rider to adjust the positioning of the foot plate 1 relative to the U-shaped attachment shank 8 and the connecting structural member 13. This provides additional versatility and customizability for the present invention to meet the needs and preferences of a variety of individuals, and fit a larger variety of shoe sizes. For this, the present invention further comprises a length-adjustment tube 19 and a locking mechanism 20. The length-adjustment tube 19 is an elongated tubular structure that is sized and shaped complimentary to the second support leg 16. The length-adjustment tube 19 allows the foot plate 1 to be positioned at different points on the second support leg 16. Specifically, the length-adjustment tube 19 is positioned parallel and adjacent to the foot plate 1, extending from the front end 3 of the foot plate 1 to the rear end 4 of the foot plate 1. Additionally, the length-adjustment tube 19 is centrally connected to a bottom surface 6 of the foot plate 1. The second support shank is slidably engaged within the length-adjustment tube 19 to allow for relative translation. To prevent the relative rotation between the second support shank and the length-adjustment tube 19, a cross-section of the second support leg 16 and an internal cavity of the length-adjustment tube 19 are each a rectangular or a square profile. The locking mechanism 20 secures the second support leg 16 within the length-adjustment tube 19 at a desired position. Specifically, the locking mechanism 20 is mechanically integrated in between the length-adjustment tube 19 and the second support leg 16. Type of mechanism/devices that may be used as the locking mechanism 20 include, but are not limited to, pin-in-slot locking mechanisms and other interlocking mechanisms.

In another embodiment of the present invention, the L-shaped support shank 14 is affixed directly to the foot plate 1. Specifically, the second support leg 16 is positioned adjacent and parallel to the bottom surface 6 of the foot plate 1 extending from the front end 3 of the foot plate 1 to the rear end 4 of the foot plate 1. This provides additional support and contact points between the rider and the horse. Additionally, the second support leg 16 is adjacently connected to the foot plate 1. In this embodiment, the first support leg 15 is oriented normal to the foot plate 1 to create clearance for the rider's foot. In yet another embodiment, the second support leg 16 is integrated directly into the foot plate 1 during manufacturing.

In yet another embodiment, the foot plate 1 can be rotated about a pitch axis of the foot plate 1 for additional configurations. In this embodiment, the foot plate 1 is rotatably mounted to the second support leg 16. This allows the rider to tilt the foot plate 1 forwards or backwards and side to side to meet his or her needs/preferences.

Referring to FIG. 2, in the preferred embodiment, the present invention further comprises a traction cover 21 and a plurality of traction features 22. The traction cover 21 and the plurality of traction features 22 increases the grip of the rider's foot on the foot plate 1. This prevents the rider's foot from sliding relative to the foot plate 1 during riding maneuvers. The traction cover 21 sleeves the foot plate 1, providing both cushioning and traction for the rider's foot. Specifically, the traction cover 21 is positioned in between the foot plate 1 and the U-shaped attachment shank 8, oriented parallel to the foot plate 1. Additionally, the traction cover 21 is adjacently attached to a top surface 7 of the foot plate 1. It is preferred that the traction cover 21 includes a lateral flange that perimetrically covers the foot plate 1 and attaches the traction cover 21 to the foot plate 1. Each of the plurality of traction features 22 is a nob, a groove, a rod, or other similar gripping feature. The plurality of traction features 22 is positioned adjacent to the traction cover 21, opposite the foot plate 1. Additionally, the plurality of traction features 22 is distributed about the traction cover 21 to provide grip at multiple points on the traction cover 21. Furthermore, each of the plurality of traction features 22 is adjacently mounted to the traction cover 21.

In one embodiment, the present invention further comprises a safety shank 23 that ensures the saddle strap does not accidentally slip off of the U-shaped attachment shank 8. The safety shank 23 is an elongated rod or tubular structure, similar to the U-shaped attachment shank 8, that is positioned parallel and offset to the web shank 11. A fixed end 24 of the safety shank 23 is terminally connected to the second shank leg 10. A free end 25 of the safety shank 23 extends towards and is positioned adjacent to the first shank leg 9. Resultantly, the U-shaped attachment shank 8 and the safety shank 23 form a loop-like structure that ensures that during movement the straddle strap does not slide off of the web shank 11 and the second shank leg 10. The gap created in between the free end 25 of the safety shank 23 and the first shank leg 9 is used to slide the saddle strap onto and off the U-shaped attachment shank 8. It is preferred that the safety shank 23, the L-shaped support shank 14, the U-shaped attachment shank 8, the interconnecting shank 17, and the safety shank 23 are formed from a single shank design. Resultantly, the open, cantilever, parallel and conformal design of the present invention practically eliminates the chance that the rider's foot can slide too far into the stirrup or could be caught in the stirrup during an unanticipated dismount event. The single shank design, aligned in a parallel configuration to the rider's foot, supports a stable platform that distributes the rider's weight more consistently across the foot than other stirrups. The present invention does not require the use of heels on footwear and maintaining contact with the present invention only requires light pressure on the foot plate 1.

Although the invention has been explained in relation to its preferred embodiment, it is to be understood that many other possible modifications and variations can be made without departing from the spirit and scope of the invention as hereinafter claimed.

What is claimed is:

1. A J stirrup comprises:
a foot plate;
a U-shaped attachment shank;
a connecting structural member;
the U-shaped attachment shank comprises a first shank leg, a second shank leg, and a web shank;
the foot plate being mounted offset to the U-shaped attachment shank by the connecting structural member;
the first shank leg and the second shank leg being oriented normal to the foot plate;
the first shank leg being positioned parallel and coincident with a sagittal plane of the foot plate;
the first shank leg being positioned adjacent to a rear end of the foot plate;
the first shank leg being terminally connected to the connecting structural member;
the second shank leg being positioned adjacent to a front end of the foot plate;
the web shank being positioned parallel and opposite to the foot plate, across the first shank leg and the second shank leg; and
a sagittal plane of the U-shaped attachment shank being oriented at a first acute angle with the sagittal plane of the foot plate.

2. The J stirrup as claimed in claim 1 comprises:
the connecting structural member comprises an L-shaped support shank and an interconnecting shank;
the L-shaped support shank comprises a first support leg and a second support leg;
the L-shaped support shank and the interconnecting shank being positioned parallel and coincident with the sagittal plane of the foot plate;
the first support leg being positioned adjacent to the front end of the foot plate;
the second support leg being centrally mounted along the foot plate;
the interconnecting shank being terminally connected to the first support leg, opposite the second support leg;
the interconnecting shank extending towards the rear end of the foot plate;
the U-shaped attachment shank being positioned adjacent to the interconnecting shank, opposite the first support leg; and
the first shank leg being terminally connected to the interconnecting shank.

3. The J stirrup as claimed in claim 2, wherein the interconnecting shank is oriented at a first obtuse angle with the first support leg.

4. The J stirrup as claimed in claim 2, wherein the interconnecting shank is oriented parallel to the foot plate.

5. The J stirrup as claimed in claim 2 comprises:
the second support leg being positioned adjacent and parallel to a bottom surface of the foot plate;
the second support leg extending from the front end of the foot plate to the rear end of the foot plate;
the second support leg being adjacently connected to the foot plate; and
the first support leg being oriented normal to the foot plate.

6. The J stirrup as claimed in claim 2 comprises:
a length-adjustment tube;
a locking mechanism;
the length-adjustment tube being positioned parallel and adjacent to the foot plate;
the length-adjustment tube extending from the front end of the foot plate to the rear end of the foot plate;
the length-adjustment tube being centrally connected to a bottom surface of the foot plate;
the second support leg being slidably engaged within the length-adjustment tube; and
the locking mechanism being mechanically integrated in between the length-adjustment tube and the second support leg.

7. The J stirrup as claimed in claim 1 comprises:
a traction cover;
the traction cover being positioned in between the foot plate and the U-shaped attachment shank;
the traction cover being oriented parallel to the foot plate; and
the traction cover being adjacently attached to a top surface of the foot plate.

8. The J stirrup as claimed in claim 7 comprises:
a plurality of traction features;
the plurality of traction features being positioned adjacent to the traction cover, opposite the foot plate;
the plurality of traction features being distributed about the traction cover; and
each of the plurality of traction features being adjacently mounted to the traction cover.

9. The J stirrup as claimed in claim 1 comprises:
a safety shank;
the safety shank being positioned parallel and offset to the web shank;
a fixed end of the safety shank being terminally connected to the second shank leg; and
a free end of the safety shank being positioned adjacent to the first shank leg.

10. The J stirrup as claimed in claim 1, wherein the acute angle in between the sagittal plane of the foot plate and the sagittal plane of the U-shaped attachment shank ranges between 20 to 40 degrees.

11. A J stirrup comprises:
a foot plate;
a U-shaped attachment shank;
a connecting structural member;
a safety shank;
the U-shaped attachment shank comprises a first shank leg, a second shank leg, and a web shank;
the foot plate being mounted offset to the U-shaped attachment shank by the connecting structural member;
the first shank leg and the second shank leg being oriented normal to the foot plate;
the first shank leg being positioned parallel and coincident with a sagittal plane of the foot plate;
the first shank leg being positioned adjacent to a rear end of the foot plate;
the first shank leg being terminally connected to the connecting structural member;
the second shank leg being positioned adjacent to a front end of the foot plate;
the web shank being positioned parallel and opposite to the foot plate, across the first shank leg and the second shank leg;
a sagittal plane of the U-shaped attachment shank being oriented at a first acute angle with the sagittal plane of the foot plate;
the safety shank being positioned parallel and offset to the web shank;
a fixed end of the safety shank being terminally connected to the second shank leg; and
a free end of the safety shank being positioned adjacent to the first shank leg.

12. The J stirrup as claimed in claim 11 comprises:
the connecting structural member comprises an L-shaped support shank and an interconnecting shank;
the L-shaped support shank comprises a first support leg and a second support leg;
the L-shaped support shank and the interconnecting shank being positioned parallel and coincident with the sagittal plane of the foot plate;
the first support leg being positioned adjacent to the front end of the foot plate;
the second support leg being centrally mounted along the foot plate;
the interconnecting shank being terminally connected to the first support leg, opposite the second support leg;
the interconnecting shank extending towards the rear end of the foot plate;
the U-shaped attachment shank being positioned adjacent to the interconnecting shank, opposite the first support leg; and
the first shank leg being terminally connected to the interconnecting shank.

13. The J stirrup as claimed in claim 12, wherein the interconnecting shank is oriented at a first obtuse angle with the first support leg.

14. The J stirrup as claimed in claim 12, wherein the interconnecting shank is oriented parallel to the foot plate.

15. The J stirrup as claimed in claim 12 comprises:
the second support leg being positioned adjacent and parallel to a bottom surface of the foot plate;
the second support leg extending from the front end of the foot plate to the rear end of the foot plate;
the second support leg being adjacently connected to the foot plate; and
the first support leg being oriented normal to the foot plate.

16. The J stirrup as claimed in claim 12 comprises:
a length-adjustment tube;
a locking mechanism;
the length-adjustment tube being positioned parallel and adjacent to the foot plate;
the length-adjustment tube extending from the front end of the foot plate to the rear end of the foot plate;
the length-adjustment tube being centrally connected to a bottom surface of the foot plate;
the second support leg being slidably engaged within the length-adjustment tube; and
the locking mechanism being mechanically integrated in between the length-adjustment tube and the second support leg.

17. The J stirrup as claimed in claim 11 comprises:
a traction cover;
the traction cover being positioned in between the foot plate and the U-shaped attachment shank;
the traction cover being oriented parallel to the foot plate;
the traction cover being adjacently attached to a top surface of the foot plate;

18. The J stirrup as claimed in claim 17 comprises:
a plurality of traction features;
the plurality of traction features being positioned adjacent to the traction cover, opposite the foot plate;
the plurality of traction features being distributed about the traction cover; and
each of the plurality of traction features being adjacently mounted to the traction cover.

19. The J stirrup as claimed in claim 11, wherein the acute angle in between the sagittal plane of the foot plate and the sagittal plane of the U-shaped attachment shank ranges between 20 to 40 degrees.
